(19) United States
(12) Patent Application Publication
(10) Pub. No.: US 2008/0309940 A1
(43) Pub. Date: Dec. 18, 2008

(54) Method of, System For, and Medical Image Acquisition System For Imaging an Interior of a Turbid Medium Taking Into Account the Geometry of the Turbid Medium

(75) Inventors: Martinus Bernardus Van Der Mark, Eindhoven (NL); Michael Cornelis Van Beek, Eindhoven (NL); Levinus Pieter Bakker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/094,698

(22) PCT Filed: Nov. 20, 2006
(86) PCT No.: PCT/IB2006/054339

§ 371 Date: May 22, 2008

(30) Foreign Application Priority Data
Nov. 23, 2005 (EP) 05111165.6

(51) Int. Cl. G01N 21/00

(52) U.S. Cl. 356/435

(57) ABSTRACT

The invention relates to a method of imaging an interior of a turbid medium (45) comprising the following steps: accommodation of the turbid medium (45) inside a receiving volume (20); coupling transmission input light (65) from a transmission light source into the receiving volume (12), with said transmission input light (65) being chosen such that it is capable of propagating through the turbid medium (45) and with at least a part of said transmission input light (65) passing through a matching medium (50) in the receiving volume (12), said matching medium (50) being chosen to reduce optical boundary effects at an interface between the turbid medium (45) and its surroundings; detection of transmission output light emanating from the receiving volume as a result of coupling transmission input light (65) from the transmission light source into the receiving volume (12) through use of a transmission photodetector unit. The invention also relates to a system for imaging an interior of a turbid medium (45) and a medical image acquisition system both using the method. According to the invention, the method, system for imaging an interior of a turbid medium (45), and medical image acquisition system are adapted such that data relating to the exterior of the turbid medium (45) can be obtained. This object is realized in that the method further comprises the following additional steps: coupling geometry input light (70, 75, 80) from a geometry light source into the receiving volume (12), with the receiving volume comprising the turbid medium (45), with the receiving volume (12) further comprising a geometry medium (60) for surrounding the turbid medium (45) during coupling of geometry input light (70, 75, 80) into the receiving volume (12), and with the combination of the geometry input light (70, 75, 80), the geometry medium (60), and the interface being chosen for creating a contrast between the turbid medium and its surroundings; —detection of the contrast between the turbid medium (45) and its surroundings; reconstructing an image of an interior of the turbid medium (45) using the detected contrast.

### FIELD OF INVENTION

The invention relates to a method of imaging an interior of a turbid medium, said method comprising the following steps:
accommodation of the turbid medium inside a receiving volume;
coupling transmission input light from a transmission light source into the receiving volume, with said transmission input light being chosen such that it is capable of propagating through the turbid medium and with at least a part of said transmission input light passing through a matching medium in the receiving volume, said matching medium being chosen to reduce optical boundary effects at an interface between the turbid medium and its surroundings;
detection of transmission output light emanating from the receiving volume as a result of coupling transmission input light from the transmission light source into the receiving volume through use of a transmission photodetector unit.

The invention also relates to a system for imaging an interior of a turbid medium comprising:
a receiving volume for accommodating the turbid medium and for accommodating a matching medium for reducing optical boundary effects and an interface between the turbid medium and its surroundings;
a transmission light source for generating transmission input light to be coupled into the receiving volume, said transmission input light being chosen such that it is capable of propagating through the turbid medium;
a transmission photodetector unit for detecting transmission output light from the transmission light source into the receiving volume.

The invention also relates to a medical image acquisition system comprising:
a receiving volume for accommodating the turbid medium and for accommodating a matching medium for reducing optical boundary effects and an interface between the turbid medium and its surroundings;
a transmission light source for generating transmission input light to be coupled into the receiving volume, said transmission input light being chosen such that it is capable of propagating through the turbid medium.

### BACKGROUND OF THE INVENTION

An embodiment of a method, system, and medical image acquisition system of this kind is known from U.S. Pat. No. 6,327,488B1. The known method and systems can be used for imaging an interior of a turbid medium, such as biological tissues, using diffuse optical tomography. In medical diagnostics the method and systems may be used for imaging an interior of a female breast. A turbid medium, such as a breast, is accommodated inside a receiving volume. Transmission input light from a transmission light source is coupled into the receiving volume, with the transmission input light being chosen such that it is capable of propagating through the turbid medium. In diffuse optical tomography transmission input light having a wavelength within the range of 400 nm to 1400 nm is typically used. Transmission output light emanating from the receiving volume as a result of coupling transmission input light into the receiving volume is detected and used to reconstruct an image of an interior of the turbid medium. During the coupling of transmission input light into the receiving volume the turbid medium comprised in the receiving volume is surrounded by a matching medium. This matching medium has optical properties, such as its absorption coefficient, that are similar to the optical properties of the turbid medium under investigation. The matching medium is used to counteract optical boundary effects stemming from the optical coupling of the turbid medium to its surroundings and to prevent an optical short-circuit around the turbid medium inside the receiving volume. An optical short-circuit occurs when transmission output light is detected that has not been sufficiently scattered and attenuated inside the receiving volume but outside the turbid medium. In that case the intensity of the insufficiently scattered and attenuated detected transmission output light may dwarf the intensity of the detected transmission output light that has been scattered and attenuated through passage through the turbid medium. If a matching medium is used, a reference measurement may be performed without the turbid medium being comprised in the receiving volume.

It is a drawback of the known method and systems that it is not straightforward to determine the geometry of the turbid medium under investigation. Having data relating to the geometry of the turbid medium is desirable as the image reconstruction process is ill-posed. This means that for a certain set of detected signals, a plurality of reconstructed images can be made that all fit the same detected signals. The general solution to this problem is to gather as much information as possible during an examination and to use all this information in the reconstruction process.

### SUMMARY OF THE INVENTION

It is an object of the invention to make it possible to optically obtain data relating to the geometry of the turbid medium under investigation. The obtained data can then be used to improve the image reconstruction process according to the opening paragraph. According to the invention this object is realized in that the method further comprises the following additional steps:
coupling geometry input light from a geometry light source into the receiving volume, with the receiving volume comprising the turbid medium, with the receiving volume further comprising a geometry medium for surrounding the turbid medium during coupling of geometry input light into the receiving volume, and with the combination of the geometry input light, the geometry medium, and the interface being chosen for creating a contrast between the turbid medium and its surroundings;
detection of the contrast between the turbid medium and its surroundings through use of a contrast photodetector unit;
reconstructing an image of an interior of the turbid medium using the detected contrast.

The invention is based on the recognition that the combination of light that is coupled into the receiving volume, a medium surrounding the turbid medium when light is coupled into the receiving volume, and the interface between the turbid medium and its surroundings in the receiving volume when light is coupled into the receiving volume allows to create a contrast between the turbid medium and its surroundings. A contrast between the turbid medium and its surroundings in turn makes it possible to detect the exterior of the turbid medium, resulting in additional data relating to the geometry of the turbid medium being obtained. This additional data establishes a boundary condition to be used in the image reconstruction process. This boundary condition in turn reduces the number of possible images that fit a particular set of detected signals, as not all possible images will satisfy the boundary condition established by the additional data.

An embodiment of the method according to the invention is characterized in that the combination of the geometry input light and the geometry medium is chosen such that the geometry medium is substantially transparent to the geometry input light and wherein the combination of the geometry input light and the interface is chosen such that at the interface the turbid medium is substantially opaque to the geometry input light relative to its surroundings. This embodiment has the advantage that it enables to directly image the exterior of the turbid medium at the wavelength of the geometry input light.

A further embodiment of the method according to the invention is characterized in that the geometry medium is a matching medium having optical properties of reducing boundary effects between the turbid medium and its surroundings for the transmission light. This embodiment implies that the wavelength of the geometry input light lies outside the wavelength range suitable for the transmission input light. After all, at the wavelength of the transmission input light the interface separating the turbid medium from its surroundings is difficult to distinguish because of the presence of the matching medium for this wavelength. This embodiment has the advantage that data relating to the exterior of the turbid medium can be obtained with the matching medium for the transmission input light in place.

A further embodiment of the method according to the invention is characterized in that the combination of the geometry input light and the geometry medium is chosen such that the geometry input light excites a fluorescent agent comprised in the geometry medium. This embodiment has the advantage that it provides an alternative to directly imaging the exterior of the turbid medium by providing a method for imaging the volume inside the receiving volume not occupied by the turbid medium.

A further embodiment of the method according to the invention is characterized in that the geometry medium is a matching medium having optical properties of reducing boundary effects between the turbid medium and its surroundings for the transmission light. This embodiment has the advantage that it enables the use of a fluorescent agent according to the previous embodiment with a matching medium for the transmission input light in place.

A further embodiment of the method according to the invention is characterized in that the transmission input light and the geometry input light are at the same. This embodiment has the advantage that a single light source can be used both for obtaining an image of an interior of the turbid medium and obtaining data relating to the exterior of the turbid medium.

A further embodiment of the method according to the invention is characterized in that the method further comprises a step of enhancing the contrast between the turbid medium and its surroundings by accommodating a contrast enhancer at the interface between the turbid medium and its surroundings. This embodiment has the advantage that the interface between the turbid medium and its surroundings, and hence the exterior shape of the turbid medium, can be distinguished better if the contrast between the turbid medium and its surroundings is enhanced.

A further embodiment of the method according to the invention is characterized in that the contrast enhancer is chosen for at least partially reflecting geometry input light. This embodiment has the advantage that by covering a surface of the turbid medium with a contrast enhancer that at least partially reflects geometry input light, the contrast between the surface of the turbid medium and its surroundings at the wavelength of the geometry input light is enhanced. The exterior of the turbid medium becomes better visible at the wavelength of the geometry input light.

A further embodiment of the method according to the invention is characterized in that the contrast enhancer is chosen for at least partially absorbing geometry input light. This embodiment has the advantage that it provides an alternative way, compared to the previous embodiment, of enhancing the contrast between the turbid medium and its surroundings. Instead of improving the visibility of the exterior of the turbid medium at the wavelength of geometry input light, the contrast between the contour of the turbid medium and its surroundings is enhanced.

A further embodiment of the method according to the invention is characterized in that the contrast enhancer is chosen for emitting fluorescence light in response to at least a part of the geometry input light. This embodiment has the advantage that covering a surface of the turbid medium with a contrast enhancer comprising a fluorescent agent enables direct imaging of the external shape of the surface at the wavelength of the fluorescence light emitted by the fluorescent agent. Moreover, whereas light that is reflected at or near the surface of the turbid medium passes through the measurement volume twice, once prior to and once after reflection, the fluorescent light only passes through the measurement volume once as it goes from the turbid medium to a detection position. This makes image reconstruction easier.

The object of the invention is further realized with a system for imaging an interior of a turbid medium comprising:
a receiving volume for accommodating the turbid medium and for accommodating a matching medium for reducing optical boundary effects and an interface between the turbid medium and its surroundings;
a transmission light source for generating transmission input light to be coupled into the receiving volume, said transmission input light being chosen such that it is capable of propagating through the turbid medium;
a transmission photodetector unit for detecting transmission output light from the transmission light source into the receiving volume,
characterized in that
the system further comprises:
a geometry light source for generating geometry input light to be coupled into the receiving volume;
a geometry medium for surrounding the turbid medium in the receiving volume during the coupling of geometry input light into the receiving volume;
a contrast photodetector unit for detecting the contrast between the turbid medium and its surroundings by detecting output geometry light emanating from the receiving volume as a result of coupling geometry input light into the receiving volume;
an image reconstruction unit for deriving an image of an interior of the turbid medium using detected transmission output light and the detected contrast,

for carrying out the method according to any one of the previous embodiments.

A system for imaging an interior of a turbid medium would benefit from any of the previous embodiments of the method according to the invention.

An embodiment of the system for imaging an interior of a turbid medium according to the invention is characterized in that the system for imaging interior of a turbid medium further comprises a contrast enhancer for enhancing the contrast between the turbid medium and its surroundings. This embodiment has the advantage that the interface between the turbid medium and its surroundings, and hence the exterior shape of the turbid medium, can be distinguished better if the contrast between the turbid medium and its surroundings is enhanced.

A further embodiment of the system for imaging an interior of a turbid medium according to the invention is characterized in that the transmission photodetector unit and the contrast photodetector unit are comprised in a single photodetector unit. This embodiment has the advantage that there is no need for separate transmission photodetector and contrast photodetector units.

The object of the invention is further realized with a medical image acquisition system comprising:
a receiving volume for accommodating the turbid medium and for accommodating a matching medium for reducing optical boundary effects and an interface between the turbid medium and its surroundings;
a transmission light source for generating transmission input light to be coupled into the receiving volume, said transmission input light being chosen such that it is capable of propagating through the turbid medium;
a transmission photodetector unit for detecting transmission output light from the transmission light source into the receiving volume,
characterized in that
the medical image acquisition system further comprises:
a geometry light source for generating geometry input light to be coupled into the receiving volume;
a geometry medium for surrounding the turbid medium in the receiving volume during the coupling of geometry input light into the receiving volume;
a contrast photodetector unit for detecting the contrast between the turbid medium and its surroundings by detecting output geometry light emanating from the receiving volume as a result of coupling geometry input light into the receiving volume;
an image reconstruction unit for deriving an image of an interior of the turbid medium using detected transmission output light and the detected contrast,
for carrying out the method according to any one of the previous embodiments.

A medical image acquisition system would benefit from any of the previous embodiments of the method according to the invention.

An embodiment of the medical image acquisition system according to the invention is characterized in that the medical image acquisition system further comprises a contrast enhancer for enhancing the contrast between the turbid medium and its surroundings. This embodiment has the advantage that the interface between the turbid medium and its surroundings, and hence the exterior shape of the turbid medium, can be distinguished better if the contrast between the turbid medium and its surroundings is enhanced.

A further embodiment of the medical image acquisition system according to the invention is characterized in that the transmission photodetector unit and the contrast photodetector unit are comprised in a single photodetector unit. This embodiment has the advantage that there is no need for separate transmission photodetector and contrast photodetector units.

### BRIEF DESCRIPTION OF THE DRAWINGS

These and other aspects of the invention will be further elucidated and described with reference to the drawings, in which:

FIG. 1 shows an embodiment of the method according to the invention.

FIG. 2 shows a device for performing measurements on a turbid medium is known from the prior art.

FIG. 3 shows embodiment of the process of coupling geometry input light into the receiving volume with the combination of the geometry input light, the geometry medium, and the surface of the turbid medium chosen to create a contrast between the surface and its surroundings.

FIG. 4 shows a receiving volume comprising a turbid medium, the surface of which is partially covered by a contrast enhancer.

FIG. 5 shows an embodiment of a medical image acquisition device according to the invention.

### DETAILED DESCRIPTION OF THE EMBODIMENTS

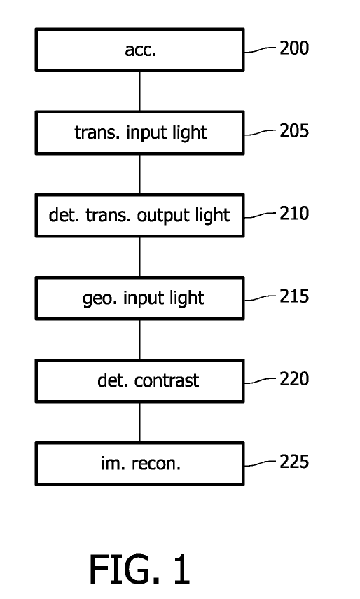

FIG. 1 shows an embodiment of the method according to the invention. In step 200 a turbid medium is accommodated inside a receiving volume. Next, in step 205, transmission input light generated by a transmission light source is coupled into the receiving volume, with the transmission input light being chosen such that it is capable of propagating through the turbid medium. In one medical application of the method, one in which the method is used for imaging an interior of a female breast, the transmission input light typically has a wavelength within the range of 400 nm to 1400 nm. At least a part of the transmission input light passes through a matching medium in the receiving volume. The matching medium is chosen to reduce optical boundary effects stemming from the optical coupling of the turbid medium to its surroundings at an interface between the turbid medium and its surroundings. To this end, the matching medium has optical characteristics, such as an absorption coefficient, that are substantially similar to corresponding optical characteristics of the turbid medium. At least a part of the transmission input light passes through the turbid medium. Transmission output light emanating from the receiving volume as a result of coupling transmission input light into the receiving volume is detected in step 210 through use of a transmission photodetector unit.

According to the invention, geometry input light from a geometry light source is coupled into the receiving volume, with the receiving volume comprising the turbid medium, with the receiving volume further than comprising a geometry medium for surrounding the turbid medium during coupling of geometry input light into the receiving volume, and with the combination of the geometry input light, the geometry medium, and the interface being chosen for creating a contrast between the turbid medium and its surroundings. This is done in step 215. A number of combinations is especially advantageous, as will be discussed below. Next, in step 220 the contrast created between the turbid medium and its surroundings is detected. In step 225 the detected contrast is used in reconstructing an image of an interior of the turbid medium. In this step the transmission output light detected in step 210 is used as well.

As mentioned, a number of combinations of geometry input light, geometry medium, and interface between the turbid medium and its surroundings is especially advantageous for creating the contrast between the turbid medium and its surroundings. This will now be further elucidated.

A first especially advantageous combination is one in which the combination of the geometry input light and the geometry medium is chosen such that the geometry medium substantially transparent to the geometry input light and wherein the combination of the geometry input light and the interface is chosen such that at the interface the turbid medium is substantially opaque to the geometry input light relative to its surroundings. One way to realize such a combination is to replace the matching medium used in step 205 with a geometry medium that is substantially transparent to the transmission input light used in step 205. In this way, at least a part of the optical discontinuity at the interface between the turbid medium and its surroundings that is removed through the use of the matching medium is reintroduced. The optical discontinuity in turn results in reflection occurring at the interface. If the reflection is sufficient at the surface of the turbid medium, this option allows direct imaging of the exterior of the turbid medium using the same light source as is used for obtaining an image of an interior of the turbid medium. In one medical application of the method, one in which the method is used for imaging an interior of a female breast, the transmission input light typically has a wavelength within the range of 400 and nm to 1400 nm. An example of a suitable geometry medium that is substantially transparent to transmission input light having a wavelength within this range is water. Although this option is especially advantageous when using transmission input light as geometry input light, this option works for all wavelengths to which the geometry medium is substantially transparent and to which the interface is substantially opaque. In the example of the medical application in which the method is used for imaging an interior of a female breast, water or a water-based substance could be used as a geometry medium. Then, the geometry medium would be substantially transparent to, for instance, blue or green light. At the same time the surface of the breast were then be sufficiently opaque to the blue or green light to allow the data relating to the exterior of the breast to be obtained. Clearly, this option enables both the direct imaging of an exterior of the turbid medium and obtaining shadow images of the turbid medium from which data relating to the exterior of the turbid medium can be deduced. In replacing the matching medium with the geometry medium it must be realized that the matching medium may exert a force on the turbid medium under investigation. If, for instance, the matching medium is a fluid, the turbid medium under investigation will experience a buoyancy force. Clearly, it is intended that the geometry of the turbid medium when coupling transmission input light into the receiving volume is the same as when geometry input light is coupled into the receiving volume. Hence, the geometry medium taking the place of the matching medium will have to exert a similar force on the turbid medium as did the matching medium. A possible way to achieve this is to replace a fluidic matching medium with a fluidic geometry medium of the same density. Above, water was mentioned as an example of a suitable geometry medium that is transparent within a wavelength range of 400 nm to 1400 nm. Should the matching medium have a higher density than water substances like salts could be added to the geometry medium to increase its density. Should the matching medium have a density lower than that of water, a transparent oil could be used as a geometry medium with additional substances added if required to match the density of the oil to that of the matching medium.

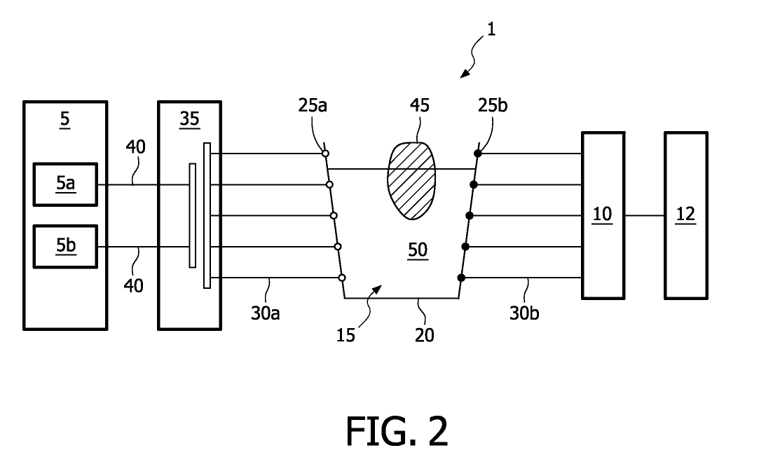

A second especially advantageous combination builds on the first one, but this time the geometry medium is a matching medium having optical properties of reducing boundary effects between the turbid medium and its surroundings for the transmission input light. In this second option, the geometry medium is no longer transparent to the transmission input light. Therefore, the transmission input light and the geometry input light can no longer be the same as was still a possibility in the first option. In the second option the geometry input light will have to have a wavelength that is different from the wavelength of the transmission input light. However, in the second option it is possible to obtain both data relating to an interior of the turbid medium and data relating to the exterior of the turbid medium without the need to replace the matching medium. Hence, the second option has a low impact on the measurement procedure followed in the known method. Clearly, this option enables both the direct imaging of an exterior of the turbid medium and obtaining shadow images of the turbid medium from which data relating to the exterior of the turbid medium can be deduced. It was already mentioned that in one medical application of the method, one in which the method is used for imaging an interior of a female breast, the transmission input light typically has a wavelength within the range of 400 nm to 1400 nm. Examples of suitable matching mediums for this wavelength range are mentioned in the discussion of FIG. 2. In the second especially advantageous combination the geometry input light will have to have a wavelength that is different from the wavelength of the transmission input light. This was explained above. Examples of suitable geometry input light within the context of the second especially advantageous combination are therefore geometry input light with a wavelength in the green part of the electromagnetic spectrum and geometry input light with a wavelength in the blue part of the electromagnetic spectrum. For light within these wavelength ranges the matching mediums mentioned in relation to FIG. 2 are substantially transparent. When imaging a female breast, the interface between the breast and its surroundings is sufficiently opaque in both parts of the electromagnetic spectrum to create a contrast between the breast and its surroundings and to use this contrast to obtain data relating to the exterior of the breast.

A third especially advantageous combination is one in which the combination of the geometry input light and the geometry medium is chosen such that the geometry input light excites a fluorescent agent comprised in the geometry medium. As a result, the fluorescent agent emits fluorescence light. This in turn creates a contrast between the turbid medium and its surroundings by creating a first region in which fluorescence light is generated in response to the geometry input light and a second region, this region being the turbid medium, in which this is not the case. Whereas in the first and second option is the exterior of the turbid medium was directly imaged, the third option enables determining the exterior shape of the turbid medium by determining the region in the receiving volume that does not emit fluorescence light in response to the geometry input light. In this sense, the third option proposes to make a negative image of the turbid medium whereas the first and second option is proposed to make a positive image. Excitation of the fluorescent agent may be achieved by geometry input light having a wavelength within the normal wavelength range of the transmission input light or by geometry input light having a wavelength outside the wavelength range of the transmission input light. In the example of the medical application of the method mentioned earlier in which an interior of a female breast is imaged, the normal wavelength range of transmission input light typically lies within the range of 400 nm to 1400 nm. If the transmission input light and the geometry input light are the same, that is if the geometry input light has a wavelength within the normal wavelength range of the transmission input light, then there is no need for a separate transmission light source and geometry light source.

A fourth especially advantageous option builds on the third option, but now the geometry medium is a matching medium having optical properties of reducing boundary effects between the turbid medium and its surroundings for the transmission input light. This option combines the use of a fluorescent geometry medium with the use of a matching medium used in step 205. In this way, there is no need to replace the matching medium with a fluorescent geometry medium that does not have matching properties for the transmission input light. Excitation of the fluorescent agent may be achieved by geometry input light having a wavelength within the normal wavelength range of the transmission input light or by geometry input light having a wavelength outside the wavelength range of the transmission input light. If the transmission input light and the geometry input light are the same, that is if the geometry input light has a wavelength within the normal wavelength range of the transmission input light, then there is no need for a separate transmission light source and geometry light source. It was already mentioned that in one medical application, one in which an interior of a female breast is imaged, the wavelength of the transmission input light typically lies within the range of 400 nm to 1400 nm. Examples of suitable matching mediums for imaging an interior of a female breast are given in the discussion relating to FIG. 2.

A fifth especially advantageous combination is one in which the contrast between the turbid medium and its surroundings created by the combination is enhanced by accommodating a contrast enhanced at the interface between the turbid medium and its surroundings. Enhancing the contrast makes the turbid medium better distinguishable from its surroundings.

A first advantageous enhancement method is to choose the contrast enhancer such that at least a part of the light arriving at the contrast enhancer is reflected. In this way, the visibility of the turbid medium at the wavelength of the light reaching the contrast enhancer, for instance, the geometry input light is improved. For the medical application of the method according to the invention in which an interior of a female breast is imaged, an example of a suitable contrast enhancer is blue body paint.

A second advantageous enhancement method is to choose the contrast enhancer such that at least a part of a light arriving at the contrast enhancer is absorbed. In this way, the turbid medium becomes darker at the wavelength of the light reaching the contrast enhancer, for instance, the geometry input light. Hence, the contrast between the turbid medium and its surroundings is enhanced. For the medical application of the method according to the invention in which an interior of a female breast is imaged, an example of a suitable contrast enhancer is a body paint containing the dye known as brilliant black.

A third advantageous enhancement method is to choose the contrast enhancer of such that it emits fluorescence light in response to at least a part of the light arriving at the contrast enhancer. In this way, the contour of the turbid medium becomes fluorescent as a result of which the external shape of the turbid medium becomes visible at the wavelength of the fluorescence light emitted by the contrast enhancer. This option is especially advantageous if the light exciting the fluorescent agent comprised in the contrast enhancer and the transmission input light are the same. Then, an interior of the turbid medium and the exterior of the turbid medium can be probed in a single measurement with a part of the light exciting the contrast enhancer and another part of the light passing through the turbid medium. For the medical application of the method according to the invention in which an interior of a female breast is imaged, an example of a suitable contrast enhancer is a body paint containing Alexa Fluor 430 or dyes with spectrums similar to that of Alexei Fluor 430.

Clearly, the sequence of steps shown in FIG. 1 is not the only possible sequence. In FIG. 1 obtaining data relating to the exterior of the turbid medium is preceded by obtaining data relating to an interior of the turbid medium. This order may be reversed. Moreover, it will be clear from the description given above that the steps of obtaining data relating to an interior of the turbid medium end of obtaining data relating to the exterior of the turbid medium may also be combined.

FIG. 2 shows a device for performing measurements on a turbid medium is known from the prior art. The device 1 includes a transmission light source 5, which may include a number of sub light sources, for example sub light sources 5a and 5b, a transmission photodetector unit 10, an image reconstruction unit 12, a receiving volume 15 bounded by a receptacle 20, said receptacle comprising a plurality of entrance positions for light 25a and a plurality of exit positions for light 25b, and light guides 30a and 30b coupled to said entrance and exit positions for light. The device 1 further includes a selection unit 35 for coupling the input light guides 40 to a number of positions selected from the plurality of entrance positions for light 25a in the receptacle 20. For the sake of clarity, entrance positions for light 25a and exit positions for light 25b have been positioned at opposite sides of the receptacle 20. In reality, however, both types of positions may be distributed around the receiving volume 15. A turbid medium 45 is placed inside the receiving volume 15. Transmission input light from the transmission light source 5 is then coupled into the receiving volume 15 The turbid medium 45 is then irradiated with transmission input light from the light source 5 from a plurality of positions by coupling the light source 5 to successively selected entrance positions for light 25a by means of the selection unit 35. The transmission input light is chosen such that it is capable of propagating through the turbid medium 45. Transmission output light emanating from the receiving volume 15 as a result of coupling transmission input light into the receiving volume 15 is detected from a plurality of positions through use of exit positions for light 25b and transmission photodetector unit 10. The detected transmission output light is then used to reconstruct an image of an interior of the turbid medium 45. Reconstruction of an image of an interior of the turbid medium 45 based on the detected transmission output light is possible as at least part of this light has traveled through the turbid medium 45 and, as a consequence, contains information relating to an interior of the turbid medium 45. The light was intentionally chosen such that it is capable of propagating through the turbid medium 45. In the receiving volume 15, the turbid medium 45 is at least partially surrounded by a matching medium 50 which is used to counteract boundary effects stemming from the optical coupling of the turbid medium 45 with its surroundings or to prevent an optical short-circuit inside the receiving volume 15 around the turbid medium 45. During an examination aimed at imaging an interior of the turbid medium 45, transmission input light capable of propagating through the turbid medium 45 must be coupled into the turbid medium 45 in a reproducible manner without the occurrence of boundary effects such as, for example, reflections. The optical characteristics of the matching medium 50 at least partially surrounding the turbid medium 45 inside the receiving volume 15 must be such that characteristics such as, for example, the absorption coefficient match those of the turbid medium 45 being imaged for the wavelength or wavelengths of light used for imaging an interior of the turbid medium 45. Matching of optical characteristics significantly reduces boundary effects. Examples of such mediums are a mixture of soy oil, egg-phospholipids, glycerol anhydride, sodium hydroxide and water, and a mixture of distilled water, titanium dioxide, a dye, and a polymer.

In FIG. 2 the receiving volume 15 is bounded by receptacle 20. However, this need not always be the case.

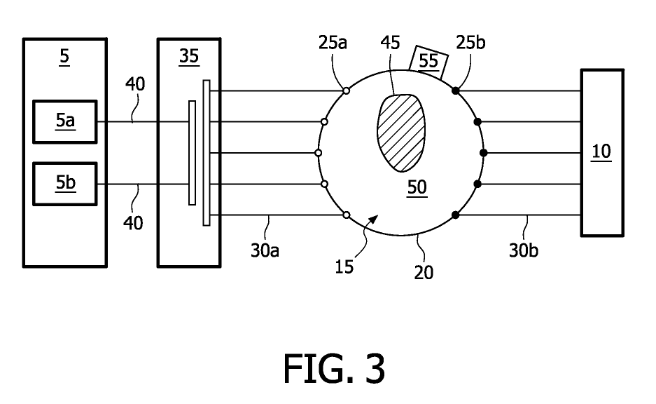

FIG. 3 shows an embodiment of the process of coupling geometry input light into the receiving volume with the combination of the geometry input light, the geometry medium, and the surface of the turbid medium chosen to create a contrast between the surface and its surroundings. FIG. 3 is a plan view of the device 1 depicted in FIG. 2. The turbid medium 45 is placed inside the receiving volume 15 bounded by the receptacle 20 and is at least partially surrounded by the matching medium 50. The optical characteristics of the matching medium 50 are such that characteristics such as the absorption coefficient, the refractive index, and scattering coefficient match those of the turbid medium 45 being imaged for the wavelength or wavelengths of the transmission input light used for imaging an interior of the turbid medium 45. Geometry input light from the geometry light source 5 is then coupled into the receiving volume 15. The combination of the geometry input light, the matching medium 50, and the interface between the turbid medium 45 and its surroundings is chosen such that the matching medium 50 is relatively transparent to the geometry input light and such that the turbid medium 45 is substantially opaque to the geometry input light relative to the opacity of the surroundings of the turbid medium 45 to that light. Here, the geometry light source is taken to be the same light source as the transmission light source. Alternatively, the geometry light source and the transmission light source may be sub light sources of a single light source as is illustrated in FIG. 2 with sub light sources 5a and 5b, or two entirely separate light sources. Examples of such mediums have been given in the description relating to FIG. 2. Geometry output light emanating from the receiving volume 15 as a result of coupling geometry input light into the receiving volume 15 is detected through exit positions for light 25b coupled to the geometry photodetector unit 10. Here, the geometry photodetector unit and the transmission photodetector unit as shown in FIG. 2 are supposed to be the same. It will be clear that, as an alternative, separate units may be used for detecting transmission output light and geometry output light. Clearly, the process illustrated in FIG. 3 can be used to obtain direct images of an exterior of the turbid medium 45 or to obtain a series of shadow images of the turbid medium 45 from which data relating to the external shape of the turbid medium 45 can be deduced. In FIG. 3 the geometry photodetector unit 10 receives geometry output light using exit positions for light 25b and light guides 30b. Data relating to the exterior of the turbid medium 45 can then be obtained using tomographic techniques like the techniques used during an examination of an interior of the turbid medium 45 using transmission input light. Alternatively, data relating to the external shape of the turbid medium 45 may be obtained using one or more cameras placed, for instance, inside or around the receiving volume 15 such as camera 55. As the receiving volume 15 is bounded by a wall, ghost images caused by reflections at this wall may hamper the gathering of data relating to the exterior of the turbid medium. This is especially true if the medium at least partially surrounding the turbid medium inside the receiving volume 15 is substantially transparent to the geometry input light. Therefore, it may be useful to take measures to reduce reflections at the wall bounding the receiving volume 15. Possible measures for reducing reflections comprise the use of a wall that absorbs the geometry input light and the geometry output light and the use of a wall that is diffusely reflecting.

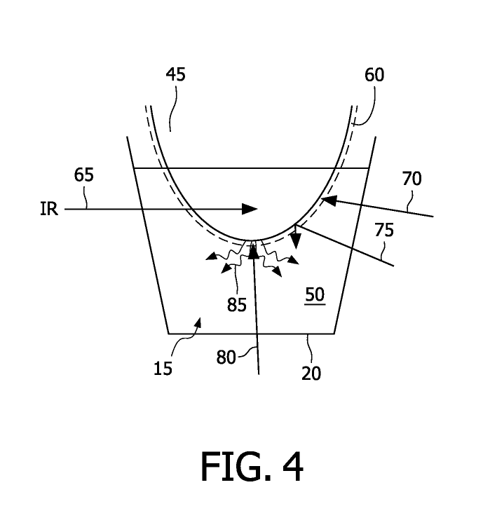

FIG. 4 shows a receiving volume comprising a turbid medium, the surface of which is partially covered by a contrast enhancer. The contrast enhancer 60 may, for example, be a cream or latex. Transmission input light ray 65 passes through the contrast enhancer 60 and enters the turbid medium 45 in order to be scattered and detected. The contrast enhancer 60 is substantially opaque to geometry input light rays 70, 75, and 80. Light rays 70, 75, and 80 may, for example, have wavelengths in the blue or green range of the electromagnetic spectrum. Light ray 70 is absorbed by the contrast enhancer 60. Light ray 75 is reflected by the contrast enhancer 60. Light ray 80 causes fluorescent emission 85 in the contrast enhancer 60.

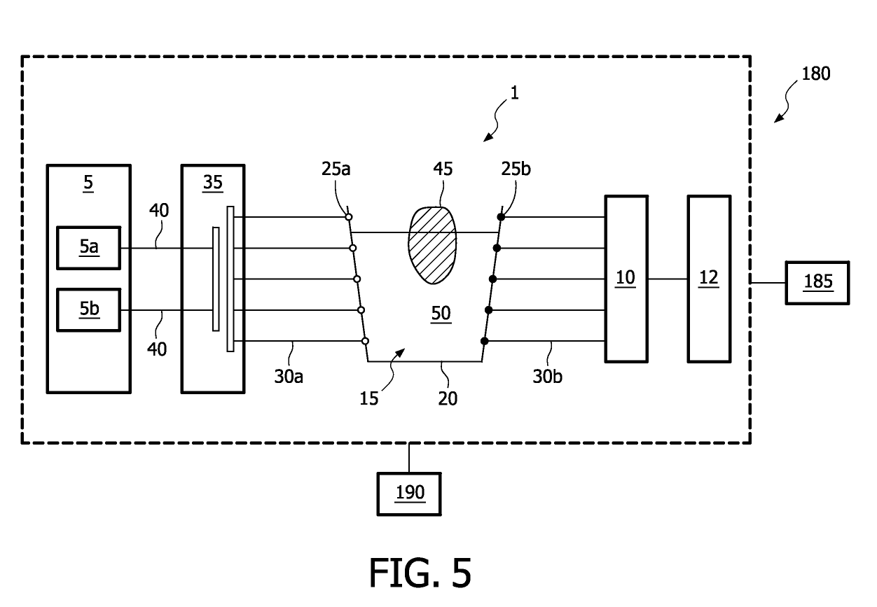

FIG. 5 shows an embodiment of a medical image acquisition device according to the invention. The medical image acquisition device 180 comprises the device 1 discussed in FIG. 2 as indicated by the dashed square. In addition to the device 1 the medical image acquisition device 180 further comprises a screen 185 for displaying an image of an interior of the turbid medium 45 and an input interface 190, for instance, a keyboard enabling and operated to interact with the medical image acquisition device 180.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the system claims enumerating several means, several of these means can be embodied by one and the same item of computer readable software or hardware. The mere fact that certain measures are recited in mutually different dependent claims does not indicate that a combination of these measures cannot be used to advantage.

1. A method of imaging an interior of a turbid medium, said method comprising the following steps:
accommodation of the turbid medium inside a receiving volume;
coupling transmission input light from a transmission light source into the receiving volume, with said transmission input light being chosen such that it is capable of propagating through the turbid medium and with at least a part of said transmission input light passing through a matching medium in the receiving volume, said matching medium being chosen to reduce optical boundary effects at an interface between the turbid medium and its surroundings;
detection of transmission output light emanating from the receiving volume as a result of coupling transmission input light from the transmission light source into the receiving volume through use of a transmission photodetector unit,
characterized in that
the method further comprises the following additional steps:
coupling geometry input light from a geometry light source into the receiving volume, with the receiving volume comprising the turbid medium, with the receiving volume further comprising a geometry medium for surrounding the turbid medium during coupling of geometry input light into the receiving volume, and with the combination of the geometry input light, the geometry medium, and the interface being chosen for creating a contrast between the turbid medium and its surroundings;
detection of the contrast between the turbid medium and its surroundings through use of the contrast photodetector unit;
reconstruction of an image of an interior of the turbid medium using a the detected contrast.

2. A method as claimed in claim 1, wherein the combination of the geometry input light and the geometry medium is chosen such that the geometry medium is substantially transparent to the geometry input light and wherein the combination of the geometry input light and the interface is chosen such that at the interface the turbid medium is substantially opaque to the geometry input light relative to its surroundings.

3. A method as claimed in claim 2, wherein the geometry medium is the matching medium having optical properties of reducing boundary effects between the turbid medium and its surroundings for the transmission light.

4. A method as claimed in claim 1, wherein the combination of the geometry input light and the geometry medium is chosen such that the geometry input light excites a fluorescent agent comprised in the geometry medium.

5. A method as claimed in claim 4, wherein the geometry medium is the matching medium having optical properties of reducing boundary effects between the turbid medium and its surroundings for the transmission light.

6. A method as claimed in claims 1, wherein the transmission input light and the geometry input light are at the same.

7. A method as claimed in claim 1, further comprising a step of enhancing the contrast between the turbid medium and its surroundings by accommodating a contrast enhancer (60) at the interface between the turbid medium and its surroundings.

8. A method as claimed in claim 6, wherein the contrast enhancer is chosen for at least partially reflecting geometry input light.

9. A method as claimed in claim 6, wherein the contrast enhancer is chosen for at least partially absorbing geometry input light.

10. A method as claimed in claim 6, wherein the contrast enhancer is chosen for emitting fluorescence light in response to at least a part of the geometry input light.

11. A system for imaging an interior of a turbid medium comprising:
a receiving volume for accommodating the turbid medium and for accommodating a matching medium for reducing optical boundary effects and an interface between the turbid medium and its surroundings;
a transmission light source for generating transmission input light to be coupled into the receiving volume, said transmission input light being chosen such that it is capable of propagating through the turbid medium;
a transmission photodetector unit for detecting transmission output light from the transmission light source into the receiving volume,
characterized in that
the system further comprises:
a geometry light source for generating geometry input light to be coupled into the receiving volume;
a geometry medium for surrounding the turbid medium in the receiving volume during the coupling of geometry input light into the receiving volume;
a contrast photodetector unit for detecting the contrast between the turbid medium and its surroundings by detecting output geometry light emanating from the receiving volume as a result of coupling geometry input light into the receiving volume;
an image reconstruction unit for deriving an image of an interior of the turbid medium using detected transmission output light and the detected contrast,
for carrying out the method according to claim 1.

12. A system for imaging an interior of a turbid medium as claimed in claim 11, wherein the system further comprises a contrast enhancer for enhancing the contrast between the turbid medium and its surroundings.

13. A system for imaging an interior of a turbid medium as claimed in claim 11, wherein the transmission photodetector unit and the contrast photodetector unit are comprised in a single photodetector unit.

14. A medical image acquisition system comprising:
a receiving volume for accommodating the turbid medium and for accommodating a matching medium for reducing optical boundary effects and an interface between the turbid medium and its surroundings;
a transmission light source for generating transmission input light to be coupled into the receiving volume, said transmission input light being chosen such that it is capable of propagating through the turbid medium;
a transmission photodetector unit for detecting transmission output light from the transmission light source into the receiving volume,
characterized in that
the medical image acquisition system further comprises:
a geometry light source for generating geometry input light to be coupled into the receiving volume;
a geometry medium for surrounding the turbid medium in the receiving volume during the coupling of geometry input light into the receiving volume;
a contrast photodetector unit for detecting the contrast between the turbid medium and its surroundings by detecting output geometry light emanating from the receiving volume as a result of coupling geometry input light into the receiving volume;
an image reconstruction unit for deriving an image of an interior of the turbid medium using detected transmission output light and the detected contrast,
for carrying out the method according to claim 1.

15. A medical image acquisition system as claimed in claim 14, wherein the system further comprises a contrast enhancer for enhancing the contrast between the turbid medium and its surroundings.

16. A medical image acquisition system as claimed in claim 14, wherein the transmission photodetector unit and the contrast photodetector unit are comprised in a single photodetector unit.
